(19) United States
(12) Patent Application Publication
(10) Pub. No.: US 2026/0140886 A1
(43) Pub. Date: May 21, 2026

(54) REQUEST PROCESSING METHOD AND APPARATUS

(71) Applicant: Smarter Silicon (Shanghai) Technologies Co., Ltd., Shanghai (CN)

(72) Inventors: Zibo RAN, Shanghai (CN); Tao LIU, Shanghai (CN); Wei YUAN, Shanghai (CN); Zhilong WANG, Shanghai (CN)

(21) Appl. No.: 19/384,528

(22) Filed: Nov. 10, 2025

(30) Foreign Application Priority Data
Nov. 21, 2024 (CN) 202411676063.9

(51) Int. Cl. G06F 12/1027; G06F 12/06

(52) U.S. Cl. CPC G06F 12/1027; G06F 12/0646

(57) ABSTRACT

A request processing method includes receiving an access request, obtaining, in response to the access request meeting an access stream matching condition, target configuration information of a target access stream to which the access request belongs, and processing the access request according to the target configuration information, to obtain a physical address corresponding to the access request.

### CROSS-REFERENCE TO RELATED APPLICATION

This application claims priority to Chinese Patent Application No. 202411676063.9, filed on Nov. 21, 2024, the entire content of which is incorporated herein by reference.

### TECHNICAL FIELD

The present disclosure generally relates to the request processing technology field and, more particularly, to a request processing method and apparatus.

### BACKGROUND

A system memory management unit (SMMU) mainly translates a virtual address (VA) issued by a subsystem device into a physical address (PA). Usually there are multiple subsystem devices in a system, and SMMU can obtain an access request initiated by a subsystem to access a memory, translate a virtual address contained in the request into a physical address and output, so that the subsystem can access data at a corresponding physical address.

In related technologies, SMMU can cache configuration information in a configuration cache unit; and when receiving an access request from the subsystem, the SMMU searches for the configuration information corresponding to the access request in the configuration cache unit, and then realizes the above address translation based on the found configuration information.

This scheme requires frequent search for configuration cache units during address translation, resulting in increased power consumption of SMMU.

### SUMMARY

In accordance with the disclosure, there is provided a request processing method including receiving an access request, obtaining, in response to the access request meeting an access stream matching condition, target configuration information of a target access stream to which the access request belongs, and processing the access request according to the target configuration information, to obtain a physical address corresponding to the access request.

Also in accordance with the disclosure, there is provided a request processing apparatus including a system memory management module including a duplicate detection unit and a translation lookaside buffer unit. The duplicate detection unit is configured to receive an access request, and obtain, in response to the access request meeting an access stream matching condition, target configuration information of a target access stream to which the access request belongs. The translation lookaside buffer unit is configured to process the access request according to the target configuration information to obtain a physical address corresponding to the access request.

### BRIEF DESCRIPTION OF THE DRAWINGS

FIG. 1 illustrates a schematic flowchart of a request processing method consistent with the present disclosure.

FIG. 2 illustrates a schematic diagram of system structure consistent with the present disclosure.

FIG. 3 illustrates a schematic structural diagram of a system memory management unit consistent with the present disclosure.

FIG. 4 is a schematic diagram showing a queue according to the embodiment of the present disclosure.

### DETAILED DESCRIPTION OF THE EMBODIMENTS

Solutions and features of the present disclosure are described with reference to the accompanying drawings.

Various modifications may be made to embodiments of the present disclosure. Therefore, the description above and below should not be regarded as a limitation, but merely as examples of embodiments. Those skilled in the art can conceive other modifications within the scope and spirit of the present disclosure. Obviously, the described embodiments are only some but not all of the embodiments of the present application.

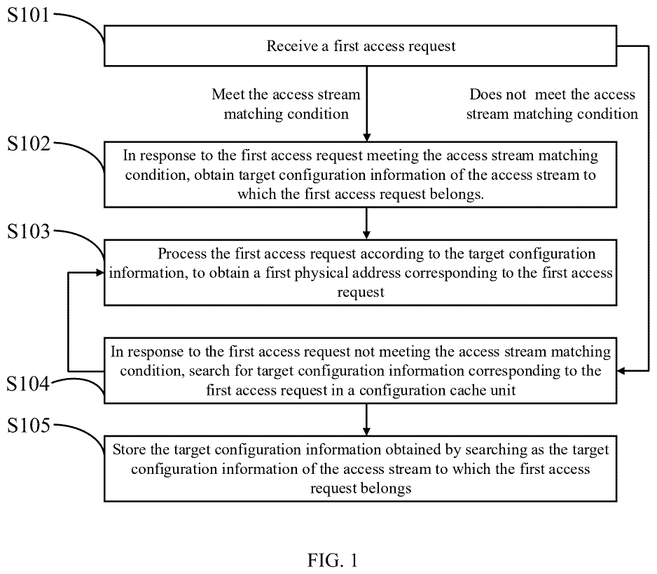

Embodiments of the present disclosure provide a request processing method, as shown in FIG. 1, which is a flowchart of the method.

At S101, a first access request is received.

The method provided by the disclosure can be executed by the System Memory Management Unit (SMMU) of an electronic device.

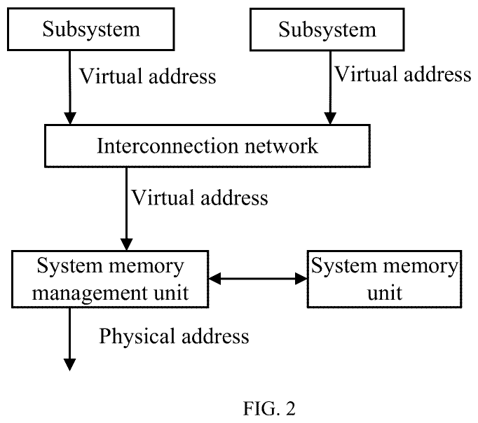

As shown in FIG. 2, the SMMU can be connected to several subsystems through an interconnection network. The first access request can be an access request sent by any of the subsystems through the interconnection network to access memory. The access request needs address translation through the SMMU.

The first access request can carry a virtual address that needs to be translated, which is recorded as a first virtual address. The first access request can also carry an access stream identity (such as a stream ID), or an access stream identity and a sub-access stream identity (e.g., a sub-stream ID). The access stream identity is used to indicate to which access stream the first access request belongs, and the sub-access stream identity is used to indicate to which sub-access stream the first access request belongs.

A subsystem can correspond to several access streams. Each access stream can include several sub-access streams. The first access request issued by the subsystem can belong to any access stream corresponding to the subsystem, and any sub-access stream of the access stream to which the first access request belongs. The access stream to which the first access request belongs is also referred to as a “candidate access stream.”

If the access stream to which the first access request belongs does not contain sub-access streams, or only contains one sub-access stream, the first access request is not required to carry the sub-access stream identity. If the access stream to which the first access request belongs contains multiple sub-access streams, the first access request can carry both the access stream identity and the sub-access stream identity.

At S102, in response to the first access request meeting an access stream matching condition, target configuration information of the access stream to which the first access request belongs is obtained.

Each access stream corresponds to specific configuration information used for address translation, and the configuration information corresponding to different access streams is different. When an access stream includes multiple sub-access streams, each sub-access stream corresponds to specific configuration information, and the configuration information corresponding to different sub-access streams is different. When an access stream does not contain sub-access stream or contains only one sub-access stream, the access stream can correspond to only one piece of configuration information. The configuration information of the access stream to which the first access request belongs is recorded as the target configuration information.

The access stream to which the first access request belongs can be an access stream (if the access stream does not contain sub-access streams) or a sub-access stream of an access stream. For example, the first access request can belong to access stream 1 or access stream 2. When the first access request belongs to access stream 1, the first access request can specifically belong to sub-access stream 1 contained in access stream 1, or to sub-access stream 2 contained in access stream 1.

The access stream to which the first access request belongs can be determined based on the access stream identity and/or sub-access stream identity carried by the first access request. For example, if the first access request carries access stream identity 1, it can be determined that the first access request belongs to access stream 1 and not to access stream 2. If the first access request carries both access stream identity 1 and sub-access stream identity 1, it can be determined that the first access request belongs to sub-access stream 1 contained in access stream 1.

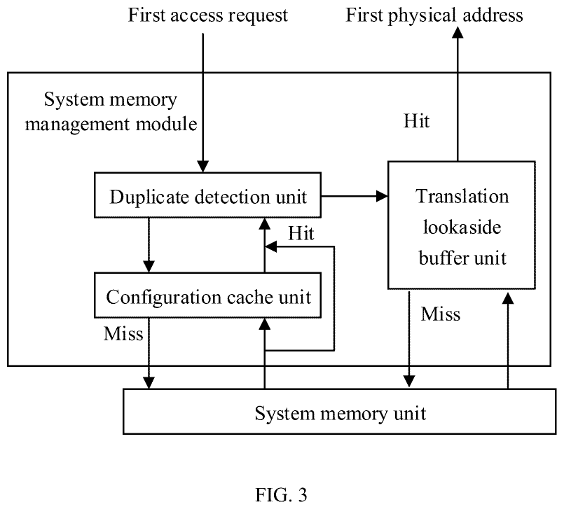

Consistent with the disclosure, as shown in FIG. 3, the SMMU can include a configuration cache unit and a duplicate detection unit for searching configuration information in the configuration cache unit. The duplicate detection unit can search the configuration information of any access stream and sub-access stream from the configuration cache unit of SMMU, and store the found configuration information.

In the initial state (e.g. when first started), the duplicate detection unit can save no configuration information. In this case, whenever obtaining an access request, the duplicate detection unit can store the access stream identity and/or sub-access stream identity carried by the access request, and after determining that the access request does not meet the access stream matching condition, the duplicate detection unit can initiate a search in the configuration cache unit and/or system memory unit, and then store the found configuration information of the access stream to which the access request belongs in the duplicate detection unit.

Therefore, the duplicate detection unit can store the configuration information of the access stream to which the access request belongs in the process of processing the access request. When the duplicate detection unit receives multiple access requests belonging to the same access stream or sub-access stream successively, the duplicate detection unit only needs to initiate a search operation in the configuration cache unit and/or system memory unit once when it receives the first access request, and no search is needed for subsequent access requests.

At S102, whether the first access request meets the access stream matching condition can be determined by duplicate detection unit. If it is determined that the first access request meets the access stream matching condition, it means that the duplicate detection unit has searched for the target configuration information of the access stream to which the first access request belongs from the configuration cache unit before receiving the first access request. In this case, the target configuration information stored by the duplicate detection unit can be obtained directly without having to search the configuration cache unit again.

Consistent with the disclosure, the duplicate detection unit can determine whether the first access request meets the access stream matching condition based on the access stream identity carried by the first access request.

The duplicate detection unit can also store the access stream identity of the access stream when storing the configuration information of any access stream it found. If the access stream is a sub-access stream, the duplicate detection unit can also store the sub-access stream identity. When obtaining the first access request, the duplicate detection unit can compare the access stream identity of the first access request with the access stream identity stored in the duplicate detection unit, and compare the sub-access stream identity (if any) of the first access request with the stored sub-access stream identity.

If the access stream identity and sub-access stream identity of the first access request are consistent with a certain identity stored by the duplicate detection unit, it can be determined that the first access request meets the access stream matching condition. If the access stream identity and sub-access stream identity of the first access request are inconsistent with the identity stored by the duplicate detection unit, it can be determined that the first access request does not meet the access stream matching condition. If the access stream matching condition is met, the configuration information corresponding to the same identity saved in the duplicated detection unit can be obtained as the target configuration information corresponding to the first access request, and there is no need to search for target configuration information in the configuration cache unit, thereby reducing the number of times of searching in the configuration cache unit.

For example, the duplicate detection unit can store configuration information 1 and configuration information 2, where configuration information 1 corresponds to access stream identity 1 and sub-access stream identity 1, indicating that the configuration information belongs to sub-access stream 1 of access stream 1. Configuration information 2 corresponds to access stream identity 2, indicating that the configuration information belongs to access stream 2. If the first access request carries access stream identity 1 and sub-access stream identity 1, after comparison, it can be determined that the first access request meets the access stream matching condition, and configuration information 1 is obtained as the target configuration information of access stream 1 and sub-access stream identity 1 to which the first access request belongs. If the first access request carries access stream identity 1 and sub-access stream identity 2, it can be determined that the identity of the first access request is inconsistent with any stored identity, indicating that the duplicate detection unit has not accessed the memory address of the access stream to which the first access request belongs before receiving the first access request, nor has the duplicate detection unit pre-stored the configuration information of the access stream to which the first access request belongs. As such, it is determined that the first access request does not meet the access stream matching condition.

At S103, the first access request is processed according to the target configuration information, to obtain the first physical address corresponding to the first access request.

Target configuration information for each access stream and sub-access stream can include the starting position of the page table corresponding to the access stream and the sub-access stream in the translation lookaside buffer unit of the SMMU.

At S103, the SMMU can determine the page table of the access stream to which the first access request belongs in the translation lookaside buffer unit according to the target configuration information of the access stream to which the first access request belongs, and then obtain the translation information needed for translating the first virtual address in the page table, and then translate the first virtual address into the first physical address corresponding to the first access request according to the translation information.

The beneficial effect of the present disclosure is: in the case that the received first access request meets the access stream matching condition, the target configuration information of the access stream can be obtained without the need to search the configuration cache unit. Therefore, the present disclosure can reduce the number of times of searching the configuration cache unit during address translation, thereby achieving the effect of reducing the power consumption of the SMMU.

Consistent with the disclosure, the duplicate detection unit needs to match the received access request with the information stored by the duplicate detection unit. However, the computational logic of determining whether the first access request meets the access stream matching condition in the duplicate detection unit is simpler than that of searching the configuration information in the configuration cache unit. Correspondingly, the former consumes less resources than the latter. Therefore, reducing the number of times of searching the configuration cache unit can bring greater power saving benefits, thereby reducing power consumption, improving response speed, and reducing latency. In some embodiments, as shown in FIG. 1, where it is determined that the first access request does not meet the access stream matching condition, the duplicate detection unit can obtain the target configuration information of the access stream to which the first access request belongs through the following.

At S104, in response to the first access request not meeting the access stream matching condition, the target configuration information corresponding to the first access request is searched for in the configuration cache unit. Such target configuration information being searched for is also referred to as “candidate configuration information.”

The configuration cache unit can cache multiple pieces of configuration information, as well as the identities of the access streams and sub-access streams corresponding to the configuration information. For example, the configuration cache unit can cache multiple pieces of configuration information as shown in Table 1.

TABLE 1

| | | Sub-access stream |
|---|---|---|
| Configuration information | Access stream identity | identity |
| Configuration information 3 | Access stream identity 1 | Sub-access stream |
| | | identity 2 |
| Configuration information 4 | Access stream identity 3 | None |

Configuration information 3 belongs to sub-access stream 2 in access stream 1, and configuration information 4 belongs to access stream 3.

If it is determined that the first access request does not meet the access stream matching condition, the duplicate detection unit can compare the access stream identity and sub-access stream identity carried by the first access request with the cached identity in the configuration cache unit. If the access stream identity carried by the first access request is consistent with an access stream identity in the configuration cache unit, and the sub-access stream identity carried by the first access request is consistent with a sub-access stream identity in the configuration cache unit, the first access request is determined to hit in the configuration cache unit. At this point, the configuration information corresponding to the access stream identity and sub-access stream identity in the configuration cache unit that are same as those carried by the first access request can be obtained as the target configuration information.

Based on the example in Table 1, assuming that the first access request carries access stream identity 1 and sub-access stream identity 2, it can be determined that the identity carried by the first access request is consistent with the identity in the first row of Table 1, so configuration information 3 can be obtained as the target configuration information corresponding to the first access request.

At S105, the target configuration information obtained by searching is stored as the target configuration information of the access stream to which the first access request belongs.

After finding the target configuration information, on the one hand, S103 can be executed based on the target configuration information; and on the other hand, S105 can be executed, to store the target configuration information in the duplicate detection unit, and store the access stream identity of the access stream corresponding to the target configuration information. When the duplicate detection unit obtains another access request belonging to the same access stream as the first access request, the duplicate detection unit can directly obtain the target configuration information stored in S105 as the configuration information of the access stream to which the other access request belongs, and then translate the virtual address carried by the other access request into the corresponding physical address according to the target configuration information, thereby reducing the number of times of searching the configuration cache unit.

In some embodiments, if the first access request does not hit in the configuration cache unit, that is, the target configuration information is not found in the configuration cache unit, the SMMU can initiate a request to search for the target configuration information corresponding to the first access request from the system memory unit. The obtained target configuration information can be stored in the configuration cache unit, and the target configuration information can be stored as the target configuration information of the access stream to which the first access request belongs in the duplicate detection unit.

After the target configuration information is found, on the one hand, the first access request can be processed according to S103 based on the obtained target configuration information, and on the other hand, the obtained target configuration information can be stored in the configuration cache unit and the duplicate detection unit. When the duplicate detection unit receives another access request that belongs to the same access stream as the first access request, the duplicate detection unit can directly obtain the stored target configuration information and process another access request based on the target configuration information, without having to search the configuration cache unit again, thereby reducing the number of times of searching the configuration cache unit.

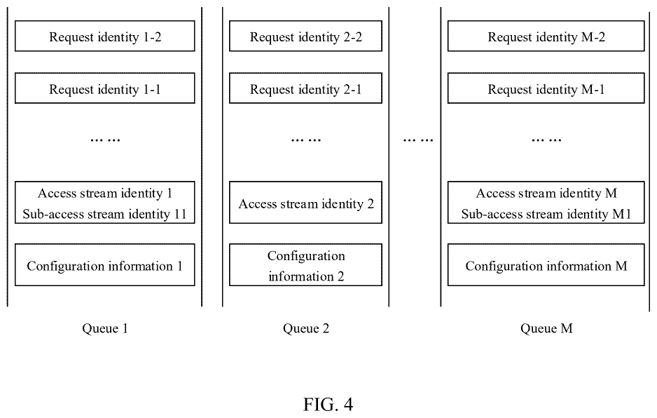

In some embodiments, as shown in FIG. 4, the duplicate detection unit can establish a corresponding queue for each access stream or for each sub-access stream contained in an access stream, and store and manage the configuration information corresponding to the access stream, the request identity of the access request belonging to the access stream, and the access stream identity of the access stream. That is, each queue can have an access stream identity for the access stream (or sub-access stream) corresponding to the queue. Each queue is distinguished by access stream identity, and the configuration information corresponding to the access stream is also stored in the queue corresponding to the access stream.

In order to store the above information through the queue, a certain amount of storage space can be allocated to the duplicate detection unit in advance, so that the duplicate detection unit can allocate these storage spaces to each queue.

For each queue, the duplicate detection unit can manage the request identities stored in that queue through a linked list. For example, the duplicate detection unit can use the request identity first written to the queue as the head node of the linked list and append each request identity written later to the linked list as a new node. When processing the request identity in the queue, request identity of each node can be taken out and processed one by one from the head node of the linked list. After each time the request identity of the head node is taken out, the next node can be updated to the head node, and so on until all request identities in the queue have been processed.

The number and capacity of queues can be determined based on the size of the storage space of the duplicate detection unit and the number of access streams. If the access requests obtained by the duplicate detection unit belong to multiple different access streams, the capacity of each queue can be reduced, so that more queues can be established in the limited storage space to store the configuration information of multiple access streams separately. If the access requests are attributed to a small number of access streams, and each access stream corresponds to a large number of access requests, the capacity of each queue can be increased and the total number of queues can be reduced, so that the request identities of multiple access requests belonging to the same access stream can be stored in one queue.

In the case of recording the configuration information corresponding to the access stream through a queue, the way a duplicate detection unit determines that any access request meets the access stream matching condition can be determining that the access stream identity of the access request matches the access stream identity of any queue.

Taking the above first access request as an example, according to FIG. 4, assuming that M queues have been established when the duplicate detection unit obtains the first access request, the duplicate detection unit can compare the access stream identity and sub-access stream identity carried by the first access request with the access stream identity and sub-access stream identity recorded by each queue in the M queues. If the access stream identity and sub-access stream identity carried by the first access request are consistent with the access stream identity and sub-access stream identity recorded in a queue in the M queues, the duplicate detection unit can determine that the first access request meets the access stream matching condition. In this case, the duplicate detection unit can obtain the target configuration information of the access stream to which the first access request belongs as follows.

The target configuration information stored in the queue that matches the first access is obtained as the target configuration information of the access stream to which the first access request belongs.

For example, assuming that the first access request carries access stream identity 1 and sub-access stream identity 11, the duplicate detection unit compares the access stream identity carried by the first access request with the access stream identity of the M queues, and finds that the first access request and queue 1 have the same access stream identity and sub-access stream identity. Thus, it is determined that the first access request meets the access stream matching condition, and configuration information 1 recorded in queue 1 can be obtained as the target configuration information corresponding to the first access request.

The manner by which the duplicate detection unit creates a queue can include, when receiving an access request and determining that the access request does not meet the access stream matching condition, creating a queue corresponding to the access stream to which the access request belongs.

Consistent with the disclosure, after determining that the first access request does not meet the access stream matching condition, the duplication detection unit can, responding to the first access request not meeting the access stream matching condition, create a queue corresponding to the access stream to which the first access request belongs. The queue is created to record the request identity of the first access request, the access stream identity of the access stream to which the first access request belongs, and the target configuration information of the access stream to which the first access request belongs as found from the configuration cache unit or system memory unit.

Taking FIG. 4 as an example, at the time of receiving the first access request, the duplicate detection unit has already established M−1 queues. After the duplicate detection unit determines that the first access request does not meet the access stream matching condition, the duplicate detection unit can create queue M corresponding to the access stream to which the first access request belongs. The duplicate detection unit can then obtain access stream identity M and sub-access stream identity M1 carried by the first access request, and record these identities in queue M as queue tags of queue M to characterize that queue M corresponds to sub-access stream M1 of the access stream, and can record the request identity (e.g., request identity M−1) of the first access request in queue M.

As mentioned earlier, when determining that the first access request does not meet the access stream matching condition, the duplicate detection unit can search for the target configuration information corresponding to the first access request from the configuration cache unit and the system memory unit. Assuming that the duplicate detection unit finds configuration information M from the configuration cache unit or system memory unit as the target configuration information corresponding to the first access request, the duplicate detection unit can store the target configuration information corresponding to the first access request by recording configuration information M in queue M. In other words, when the target configuration information corresponding to the first access request is found from the configuration cache unit and/or system memory unit, the duplicate detection unit can store the target configuration information in the created queue as the target configuration information of the access stream to which the first access request belongs.

Based on the above examples, after determining that the first access request does not meet the access stream matching condition and creating queue M, the duplicate detection unit searches for the target configuration information corresponding to the first access request from the configuration cache unit and/or the system memory unit. After finding the target configuration information, the duplicate detection unit records the target configuration information in queue M, and the target configuration information is equivalent to configuration information M shown in FIG. 4.

After creating a queue corresponding to the access stream to which the first access request belongs, if the duplicate detection unit receives a new access request that meets the access stream matching condition, and the access request and the first access request belong to the same access stream, the duplicate detection unit can record the request identity of the access request to the queue corresponding to the access stream to which the first access request belongs. For example, the duplicate detection unit can respond to a second access request and record the request identity of the second access request to the queue corresponding to the access stream to which the first access request belongs, and the second access request and the first access request belong to the same access stream.

Based on the above examples, after the duplicate detection unit obtains the second access request, the duplicate detection unit can compare the access stream identity of the second access request with the access stream identity of each queue to determine whether the second access request meets the access stream matching condition. If it is determined that the second access request meets the access stream matching condition, and it is determined that access stream identity M and sub-access stream identity M−1 carried by the second access request are consistent with queue M, the second access request and the first access request are determined as belonging to the same access stream, and then the request identity of the second access request is added to the same queue as the first access request, that is, it is added to queue M.

For each received access request, if it is determined that the access request meets the access stream matching condition, the duplicate detection unit can add the request identity of the access request to the corresponding queue in the above way.

In some embodiments, based on a plurality of established queues, when the duplicate detection unit determines that the first access request meets the access stream matching condition, the request identity of the first access request can be recorded in the matching queue first.

Further, for each queue, the duplicate detection unit can process the access requests corresponding to the request identities of various queues one by one in the order of entry. When the first access request is being processed, the duplicate detection unit obtains the target configuration information corresponding to the first access request from the queue it belongs, and executes the preceding S103 based on the target configuration information.

Taking FIG. 4 as an example, assuming that queue 1 already has two request identities when the first access request is received, which are request identity 1-1 and request identity 1-2 identified in the order of entry. After determining that the access stream identity carried by the first access request is consistent with the access stream identity of queue 1, the duplicate detection unit records request identity 1-3 of the first access request to queue 1.

When processing an access request corresponding to queue 1, the duplicate detection unit can first read the request identity 1-1, and perform the above address translation as to the access request corresponding to request identity 1-1 based on the configuration information recorded in queue 1; then read request identity 1-2, and process the access request corresponding to request identity 1-2 based on configuration information 1; then read request identity 1-3, and obtain configuration information 1 as the target configuration information of the first access request corresponding to request identity 1-3; and process the first access request based on configuration information 1 to obtain the corresponding first physical address.

In some implementations, the access request for each queue record can also be processed according to the queue polling method. Taking FIG. 4 as an example, the duplicate detection unit can execute the following polling process on queue 1. Whether there is a request identity in queue 1 is determined. If there is no request identity in queue 1, the polling process for queue 1 ends. If there is a request identity in queue 1, the request identity of the earliest queue in queue 1 and the configuration information of the queue are read in the order of entry, and are sent to the translation lookaside buffer unit to process the access request corresponding to the request identity. The polling process for queue 1 ends.

After the polling process for queue 1 is over, polling process can be executed for queue 2 and then for queue 3, and so on until each queue is polled. Then, the queues can be polled one by one again starting from queue 1.

For each queue, the request identity in the queue can be processed in a first-in, first-out manner based on the order of linked list management, that is, each time a queue is polled, the earliest written request identity in the queue is read, that is, the request identity of the head node of the linked list of the queue, and the request identity is processed according to the above polling process.

In some embodiments, multiple queues can also be polled in other orders.

For example, the queues can be polled in the order in which they were created. That is, the queue created first is polled first, the queue created second is then polled, and the queue created third is then polled, and so on until the queue created last is polled, and then the queues are polled from the first one again.

The queues can be polled according to the target write moment for each queue. The farther away the target moment of the queue is from the current moment, the earlier the polling. That is, the queue with a target moment far away from the current moment is polled first, and then the queue with the target moment closer to the current moment is polled. The target moment of a queue can be the writing moment of the request identity last written into the queue.

The queues can be polled by their priorities. The high-priority queue can be polled first, and the low-priority queue can be polled later. When the duplicate detection unit establishes a queue, the priority of the access stream corresponding to the queue can be taken as the priority of the queue, and the priority corresponding to each access stream can be determined according to the task involved in the access stream. For example, if the task involved in the access stream is related to the system basic services, the access stream can have a higher priority, and if the task involved in the access stream is related to the user's personal application, the access stream can have a lower priority.

Polling multiple queues based on the above sequences can minimize access latency by prioritizing access requests for specific access streams without increasing excessive power consumption.

In some embodiments, the duplicate detection unit may delete the data recorded by the queue or delete the queue as follows.

In response to an invalidate operation command, data stored in the queue that is to be cleared according to the invalidate operation command is deleted.

If all the data stored in a queue has been deleted, the queue is deleted. The invalidate operation command can specify the data to be cleared in a various ways. For example, data recorded by any one or more queues can be specified as the data to be cleared, the data recorded in a queue during a specific period of time can be specified as the data to be cleared, or the data recorded in the queue corresponding to one or more specified access stream identities can be specified as the data to be cleared.

After obtaining an invalidate operation command, the SMMU can delete the specified data to be cleared according to the command. After deleting the data to be cleared, the SMMU can determine whether the data recorded in each queue has all been deleted, and then delete those queues where all data has been deleted.

In some embodiments, if the data of a queue is designated as the data to be cleared, the SMMU can first process the access requests corresponding to the request identities recorded in the queue, obtain and output the physical address corresponding to each of the access requests, and then delete the queue and the data of the queue after processing all the request identities recorded in the queue.

In some embodiments, the duplicate detection unit can also delete the queue as follows. The duplicate detection unit can determine if the current total number of queues is greater than a set maximum number of queues. If the current total number of queues is greater than the maximum number of queues, the duplicate detection unit can delete those queues created earlier one by one in the order of creation time until the current total number of queues is less than or equal to the maximum number of queues. If the current total number of queues is less than or equal to the maximum number of queues, the duplicate detection unit does not need to delete the queue.

The maximum number of queues can be determined based on the storage space available to the duplicate detection unit. The larger the storage space available to the duplicate inspection unit, the larger the maximum number of queues.

In some embodiments, the SMMU can also update the configuration information stored in the duplicate detection unit in the following ways.

When it is determined that the configuration information corresponding to any access stream in the configuration cache unit or system memory unit is updated, the target configuration information of the access stream to which the first access request belongs can be replaced with the updated configuration information.

The SMMU may determine that configuration information stored in the configuration cache unit or system memory unit is updated when the SMMU receives a request or notification to update configuration information, or when an error occurs in the output physical address.

When it is determined that the configuration information corresponding to any access stream in the configuration cache unit or system memory unit is updated, the SMMU can search for the target configuration information of the access stream to which the first access request belongs from the configuration cache unit or system memory unit, and replace the configuration information recorded in the queue of the access stream to which the first access request belongs in the duplicate detection unit with the found target configuration information.

For example, the access flow to which the first access request belongs corresponds to queue M in FIG. 4, and when it is determined that the configuration information corresponding to any access stream in the configuration cache unit or system memory unit is updated, the SMMU can search for the target configuration information of the access stream to which the first access request belongs in the configuration cache unit or system memory unit, and replace configuration information M recorded in queue M with the found target configuration information.

As another example, when it is determined that the configuration information corresponding to any access stream in the configuration cache unit or system memory unit is updated, the SMMU can search for the target configuration information of the access stream to which the first access request belongs from the configuration cache unit or system memory unit, and compare the found target configuration information with the configuration information of the access stream to which the first access request belongs that is recorded in the duplicate detection unit. If the two are consistent, it means that the configuration information of the access stream has not been updated and there is no need to replace. If the two are inconsistent, the original configuration information of the duplicate detection unit can be replaced with the found target configuration information.

Embodiments of the present disclosure provide a request processing apparatus, which may include a system memory management module as shown in FIG. 3. The system memory management module includes a duplicate detection unite and a translation lookaside buffer unit.

The duplicate detection unit is configured to obtain the first access request, and in response to the first access request meeting the access stream matching condition, obtain the target configuration information of the access stream to which the first access request belongs.

The translation lookaside buffer unit is configured to process the first access request according to the target configuration information to obtain the first physical address corresponding to the first access request.

In some embodiments, the system memory management module also includes a configuration cache unit configured to store configuration information.

The duplicate detection unit is further configured to, in response to the first access request not meeting the access stream matching condition, search for the target configuration information corresponding to the first access request from the configuration cache unit, and store the found target configuration information as the target configuration information of the access stream to which the first access request belongs.

For the working principle of the above system memory management module, reference can be made to the request processing method of the above embodiments, the detailed description of which is omitted.

Embodiments of the present disclosure also provide an electronic device including one or more memories storing one or more instructions, and one or more processors configured to execute the one or more instructions to implement a method consistent with the disclosure, such as any of the example methods described above.

Embodiments of the present disclosure also provide a non-transitory computer-readable storage medium storing one or more instructions that, when executed by one or more processors, cause an electronic device having the one or more processors to implement a method consistent with the disclosure, such as any of the example methods described above.

Embodiments in this specification are described in a progressive manner, and each embodiment focuses on the differences from other embodiments, and the same and similar parts among various embodiments can be cross-referenced.

For the convenience of description, the above systems or devices are described separately by various modules or units. Of course, the functions of each unit can be implemented in the same software and/or hardware in the implementation of the present application.

From the above description of the embodiment, it can be seen that persons of ordinary skill in the art can understand that the present application can be realized by means of software and the necessary general hardware platform. Based on this understanding, the technical solution of the present application can be embodied in the form of a software product that can be stored in a storage medium, such as ROM/RAM, disk, optical disc, etc., and includes a number of commands to enable a computer device (which may be a personal computer, server, or network device, etc.) to execute the method described in each embodiment or part of an embodiment of the present disclosure.

Further, relational terms such as first, second, third, and fourth are only used to distinguish one entity or operation from another, without necessarily requiring or implying any such actual relationship or order among these entities or operations. Moreover, terms such as “include,” “comprise” or any other variation thereof are intended to cover non-exclusive inclusions, so that a process, method, article, or device that includes a series of elements includes not only those elements, but also other elements not explicitly listed, or elements inherent in such a process, method, article, or device. In the absence of further restrictions, the use of the phrase “comprising a . . . ” associated with an element does not exclude the existence of additional identical elements in the process, method, article, or device that includes the elements.

For persons of ordinary skills in the art, various improvements and modifications can also be made without departing from the spirits of the present disclosure, and these improvements and modifications should also be regarded as being included in the scope of the present disclosure.

What is claimed is:

1. A request processing method comprising:
receiving an access request;
obtaining, in response to the access request meeting an access stream matching condition, target configuration information of a target access stream to which the access request belongs; and
processing the access request according to the target configuration information, to obtain a physical address corresponding to the access request.

2. The method according to claim 1, further comprising:
searching, in response to the access request not meeting the access stream matching condition, a configuration cache unit for candidate configuration information corresponding to the access request; and
storing the candidate configuration information as the target configuration information.

3. The method according to claim 2, further comprising:
searching for the candidate configuration information in a system memory unit in response to the candidate configuration information not being found in the configuration cache unit; and
storing the candidate configuration information in the configuration cache unit, and storing the candidate configuration information as the target configuration information.

4. The method according to claim 1, wherein:
the access request meeting the access stream matching condition includes an access stream identity of the access request matching an access stream identity of a queue; and
the queue stores configuration information corresponding to an access stream corresponding to the access stream identity of the queue.

5. The method according to claim 4, wherein obtaining the target configuration information includes:
obtaining the configuration information stored in the queue as the target configuration information.

6. The method according to claim 1, further comprising:
creating, in response to the access request not meeting the access stream matching condition, a queue corresponding to the target access stream;
wherein the queue records a request identity of the access request, an access stream identity of the target access stream, and candidate configuration information of the target access stream found from at least one of a configuration cache unit or a system memory unit.

7. The method according to claim 6,
wherein the access request is a first access request;
the method further comprising:
recording, in response to receiving a second access request, a request identity of the second access request in the queue, the second access request also belonging to the target access stream.

8. The method according to claim 7, further comprising:
storing, in response to finding the candidate configuration information in the at least one of the configuration cache unit or the system memory unit, the candidate configuration information in the queue as the target configuration information; and
processing access requests corresponding to request identities recorded in the queue one by one according to the target configuration information in an order in which the request identities are entered into the queue.

9. The method according to claim 1, further comprising:
deleting, in response to an invalidate operation command, data stored in a queue that is indicated by the invalidate operation command as being to be cleared; and
deleting the queue in response to all data stored in the queue having been deleted.

10. The method according to claim 1, further comprising:
replacing, in response to determining that configuration information corresponding to an access stream and stored in a configuration cache unit or a system memory unit has been updated, the target configuration information with updated configuration information.

11. A request processing apparatus comprising:
a system memory management module, including:
a duplicate detection unit configured to:
receive an access request; and
obtain, in response to the access request meeting an access stream matching condition, target configuration information of a target access stream to which the access request belongs; and
a translation lookaside buffer unit configured to process the access request according to the target configuration information to obtain a physical address corresponding to the access request.

12. The apparatus according to claim 11, wherein:
the system memory management module further includes a configuration cache unit configured to store configuration information; and
the duplicate detection unit is further configured to:
search, in response to the access request not meeting the access stream matching condition, the configuration cache unit for candidate configuration information corresponding to the access request; and
store the candidate configuration information as the target configuration information.

13. The apparatus according to claim 12, further comprising:
a system memory unit;
wherein the duplicate detection unit is further configured to:
search for the candidate configuration information in the system memory unit in response to the candidate configuration information not being found in the configuration cache unit; and
store the candidate configuration information in the configuration cache unit, and store the candidate configuration information as the target configuration information.

14. The apparatus according to claim 11, wherein:
the access request meeting the access stream matching condition includes an access stream identity of the access request matching an access stream identity of a queue; and
the queue stores configuration information corresponding to an access stream corresponding to the access stream identity of the queue.

15. The apparatus according to claim 14, wherein the duplicate detection unit is further configured to, when obtaining the target configuration information:
obtain the configuration information stored in the queue as the target configuration information.

16. The apparatus according to claim 11, wherein:
the duplicate detection unit is further configured to create, in response to the access request not meeting the access stream matching condition, a queue corresponding to the target access stream; and
the queue records a request identity of the access request, an access stream identity of the target access stream, and candidate configuration information of the target access stream found from at least one of a configuration cache unit of the system memory management module or a system memory unit.

17. The apparatus according to claim 16, wherein:
the access request is a first access request; and
the duplicate detection unit is further configured to:
record, in response to receiving a second access request, a request identity of the second access request in the queue, the second access request also belonging to the target access stream.

18. The apparatus according to claim 17, wherein the duplicate detection unit is further configured to:
store, in response to finding the candidate configuration information in the at least one of the configuration cache unit or the system memory unit, the candidate configuration information in the queue as the target configuration information; and
process access requests corresponding to request identities recorded in the queue one by one according to the target configuration information in an order in which the request identities are entered into the queue.

19. The apparatus according to claim 11, wherein the duplicate detection unit is further configured to:
delete, in response to an invalidate operation command, data stored in a queue that is indicated by the invalidate operation command as being to be cleared; and
delete the queue in response to all data stored in the queue having been deleted.

20. The apparatus according to claim 11, wherein the duplicate detection unit is further configured to:
replace, in response to determining that configuration information corresponding to an access stream and stored in a configuration cache unit or a system memory unit has been updated, the target configuration information with updated configuration information.
